(19) United States
(12) Patent Application Publication
(10) Pub. No.: US 2007/0150415 A1
(43) Pub. Date: Jun. 28, 2007

(54) Method and apparatus for creating and entering a PIN code

(76) Inventors: Ross E. Bundy, St. Joseph, IL (US); Philip M. Brewer, Champaign, IL (US)

Correspondence Address: MOTOROLA INC, 600 NORTH US HIGHWAY 45, ROOM AS437, LIBERTYVILLE, IL, 60048-5343, US

(21) Appl. No.: 11/317,038

(22) Filed: Dec. 22, 2005

(51) Int. Cl. H04L 9/00

(52) U.S. Cl. 705/51

(57) ABSTRACT

A method and apparatus for creating a link key and enabling a secure communication link between two or more devices in which a biometric information sample is obtained (102); a PIN code is produced using the biometric information sample (104); and a link key is created using the PIN code (106). In another step, the link key may be used to authenticate future communications between devices.

### FIELD OF THE INVENTION

The present invention relates generally to device pairing processes. More particularly, the present invention relates to a secure method and apparatus for creating and entering a personal identification number (PIN) code for such a pairing process.

### BACKGROUND

An important stage during the initiation of a secure wireless communication link between electronic devices is the pairing process, in which the devices are primed to recognize and authenticate each other for the subsequent exchange of information between the devices. Bluetooth technology, a well-known wireless standard, ensures that many different types of devices with wireless capabilities (e.g., personal computers, keyboards, headsets, mobile phones, radios, handheld devices, etc.), can communicate with each other without the need for extensive set up by the user. Bluetooth-enabled devices are typically capable of virtually seamless automatic communication with each other. Typically, a device is equipped with Bluetooth hardware (radio and base band controller) and software (Bluetooth protocol stack and user interface). The software allows a user to configure options, discover and connect to nearby Bluetooth-enabled devices, and perform operations over the Bluetooth link. Typically, a user initiates a Bluetooth connection between two devices that are in relatively close proximity to one another. To initiate the connection, the user opens Bluetooth client software on one of the devices, and “discovers” nearby devices that are configured to be “discoverable.” For security purposes, a device can generally be configured to not be discoverable by other devices.

Pairing, also referred to as bonding, is a method used to initiate a private connection between two devices. Establishing a secure link key is a crucial component of secure communication between devices. The pairing process involves the formulation of a link key, which is used to encrypt information transmitted between the devices. If the information exchanged while generating a link key is detected by an unauthorized device during an initial encryption stage of communication between the devices, then information which is subsequently transmitted between the devices can be “sniffed” or decoded by the unauthorized device. Generally, the more secure a pairing method is, the less prone a corresponding device is to being “hijacked,” or used by an unauthorized device.

For security purposes, a link key is generally required before the connection is allowed. A secure link key depends on having a good PIN code: one that is long and difficult to guess. A link key used in the pairing of devices may be generated using, for example, a multi-byte PIN code which is selected and entered by a user and stored in a device. The PIN code is stored in the devices only long enough that the two devices can work together to calculate a link key, which is then stored in the devices. In the case of Bluetooth, the standard link key mechanism has the potential to be very secure; however, the security depends upon the selection and use of a good PIN code. In other words, generation of a secure link key depends on formulation of a PIN code that is long and difficult to guess. The Bluetooth specification allows for a 16-byte PIN code, which may include, among other things, alphanumeric characters and symbols. Security would be optimized by selecting a random 16-byte PIN code and entering it into the devices to be paired. However, selecting and correctly entering a PIN code having a large number of bytes into devices to be paired may be a difficult and cumbersome process. Consequently, most PIN codes are simply four-digit numbers.

Therefore, the need exists for a non-cumbersome method to allow an individual user to efficiently and effectively generate a long and difficult-to-guess PIN code during the link key generation process. Moreover, it would be highly desirable to provide such a method which enables PIN code creation without requiring keypad PIN code entry.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a method for creating and entering a PIN code to be used to create a link key for a device in accordance with some embodiments.

FIG. 2 is an example of a method for creating a PIN code and link key for multiple devices in accordance with some embodiments.

FIG. 3 is an example of a method for entering a PIN code, creating a link key, and using the link key for authentication of future communications between multiple devices in accordance with some embodiments.

FIG. 4 is an example of an apparatus for creating a PIN code and a link key for multiple devices in accordance with some embodiments.

### DETAILED DESCRIPTION

Before describing in detail embodiments that are in accordance with the present invention, it should be observed that the embodiments reside primarily in combinations of method steps related to a method for creating and entering a PIN code used for creating a link key which is suitable for pairing devices. Accordingly, the method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . .” does not, without more constraints, preclude the existence of additional identical elements in the process, method, article, or apparatus that comprises the element.

It will be appreciated that embodiments of the invention described herein may be comprised of one or more conventional processors and custom stored program instructions that control the one or more processors to implement, in conjunction with certain non-processor circuits, some, most, or all of the functions of a method for creating and entering a PIN code to be used to create a link key which is suitable for pairing devices described herein. The non-processor circuits may include, but are not limited to, a radio receiver, a radio transmitter, signal drivers, clock circuits, power source circuits, and user input devices. As such, these functions may be interpreted as steps of a method to perform a method for creating and entering a PIN code used to create a link key which is suitable for pairing devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Illustrative embodiments in accordance with the invention include a method for creating and entering a PIN code produced using biometric information, which may be obtained from a user of the device(s) or from another person. Illustrative embodiments also include a method of creating a link key using the PIN code to authenticate future communications between devices. The PIN code may be a multi-byte PIN code having a selected number of bytes, and may be numeric or alpha-numeric, for example. The PIN code may have at least 16 bytes, although PIN codes having fewer than 16 bytes may be used. In any case, the PIN code is typically lengthy and difficult to guess. The length and content of PIN codes in an actual implementation would conform to the particular requirements of the devices. One benefit of producing the PIN code using a biometric information sample obtained from a user of the device(s), or another person, is that the PIN code need not be selected, formulated and recorded, or remembered by the user or other person, and then entered into the device or separately entered into multiple devices. This enhances the ease in preparation of the device(s) for the subsequent paired exchange of information between devices, as well as provides a potentially complicated, long and difficult-to-guess, PIN code which is “carried” by the user or other person and cannot be readily deciphered, “sniffed,” or intercepted by unauthorized devices, thereby enhancing the security and preventing eavesdropping of information transmitted between paired devices.

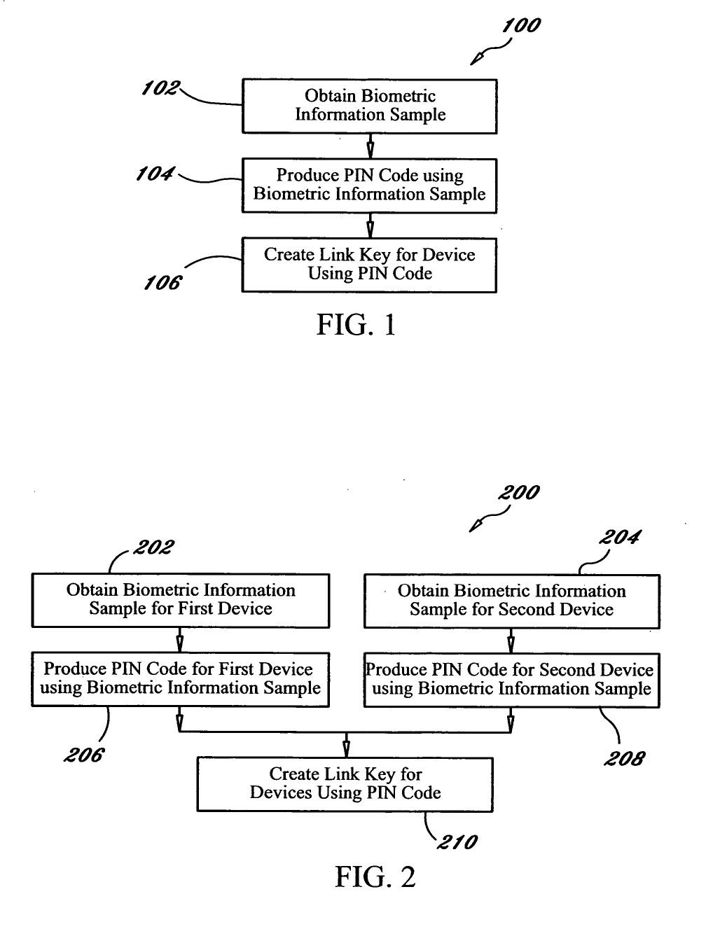

Referring initially to FIG. 1, a flow diagram 100 shows an illustrative embodiment of a method for creating and entering a PIN code to be used to create a link key for a device in accordance with some embodiments. The device for which the PIN code is created may be any type of device which is capable of receiving information communicated from one or more paired devices (or another source or sources) and/or transmitting information to one or more paired devices (or other destinations). Examples of suitable devices for implementing the method include, but are not limited to, pagers, mobile phones, personal computers, printers, keyboards, facsimile machines, modems, network interfaces devices (LAN or WAN connection devices, for example), digital cameras, headphones, and other types of wireless devices.

In a first step 102 of the method, a sample of biometric information is obtained from a device user, or other individual. The type of biometric information sample which is obtained from the user or other person may include, but is not limited to, a fingerprint; a palm print; a toe print; a retinal image; a hand geometry sample; a handwriting sample; and genetic sample (hair, saliva, skin, etc.). The biometric information sample may be obtained using a biometric imaging apparatus (not illustrated) that may be incorporated into the device or each of multiple devices to be paired. Alternatively, the biometric imaging apparatus may be physically separate from the device(s) to be paired, such as in an accessory. In this case, the biometric information sample obtained from the user is transmitted from the apparatus to the device or devices. For example, in the case of a fingerprint, the individual may place a finger in or on the biometric imaging apparatus, at which time the biometric imaging device scans the fingerprint and stores the fingerprint biometric information sample in the device or the fingerprint biometric information sample is transferred to the device. The device or accessory may have the capability to store the biometric information retrieved by the biometric imaging apparatus, along with the capability to produce a PIN code which will subsequently be used to create the link key, as will be hereinafter further described.

In a next step 104 of the method, a PIN code is generated or produced using the biometric information sample provided in step 102. The PIN code may be a multi-byte PIN code having, for example, at least 16 bytes. The PIN code may include alphanumeric and symbol characters, for example. Alternatively, the PIN code may have fewer than 16 bytes. The PIN code may be produced using the biometric information sample according to any of a variety of techniques. As an example, the PIN code may be based on characteristics of the biometric information sample itself, such as a mathematical transformation of the biometric information sample. Alternatively, multiple PIN codes may be stored in the device in association or linkage with multiple respective biometric templates, or stored patterns or images, of the same type of biometric information that will be obtained from the user (e.g., fingerprint, palm print, toe print, retinal image, hand geometry sample and handwriting sample). In this case, the sample of biometric information previously obtained from the user in step 102 is paired with the stored biometric template matching, or most closely resembling, the obtained sample of biometric information. The PIN code directly matching or most closely corresponding to the biometric template is the PIN code that will subsequently be used to create the link key for the device.

In a next step 106, the PIN code that was produced in step 104 is used to create a link key for linking the first device with a second device (or alternative source or destination of information) which is to be subsequently transmitted to or received from the first device. This may be carried out according to any suitable method known by those skilled in the art. Methods are known, for example, in which a PIN code is combined with certain fixed and ephemeral data to formulate a secret link key that can subsequently be used for authentication and encryption of paired information exchange between devices. The first device and a second device may be permanently paired with each other, in which case the link key is used to initiate communication between the devices each time communication between the devices is requested. In the case of a different user, provision may be made for changing the link key for the device by first deleting the first link key and then generating a new link key typically by carrying out steps 102, 104, and 106 of FIG. 1.

The method is suitable for creating a link key for a device that is to be exclusively paired with another device or other information source or destination over a long time period. In the case of paired devices, the same PIN code is entered into the devices and a link key is created using the PIN code. The PIN code for at least one of the devices is produced using a biometric information sample, which is subsequently used to create a link key, as was heretofore set forth in steps 102, 104 and 106 of FIG. 1. The link key may then be used for authentication and encryption of information exchanged between the devices. The stored link key is reused each time the paired devices communicate.

The method is also suitable for creating a link key for a device which is to be paired with another device or other information source or destination for only a single transaction or data exchange. In the case of single-session paired devices, the same PIN code is typically entered into both devices and a link key is created using the PIN code. The PIN code for at least one of the devices is produced using a biometric information sample, which is subsequently used to create the link key, as was heretofore set forth in steps 102, 104, and 106 of FIG. 1. The PIN code for the other device may be entered using a biometric information sample, or may be manually entered using a keypad. In the case of manual entry, the PIN code entered using a biometric information sample would be displayed on the first device so that a user could enter the PIN code into the second device. The link key may then be used for authentication of the transaction or data exchange, and may be used to encrypt information in the transaction or data exchange. After completion of the transaction or data exchange, the PIN code(s) and the link key may be deleted.

Referring to FIG. 2, a flow diagram 200 provides an illustrative embodiment of a method for creating a PIN code and link key for paired devices in accordance with some embodiments. The paired devices for which the PIN code and link key is created may be any type for which the paired and secured exchange of information between the devices is desired. Examples of suitable devices for implementing the method include, but are not limited to, pagers, mobile phones, personal computers, printers, keyboards, facsimile machines, modems, network interface devices (LAN or WAN connection devices, for example), digital cameras, headphones, and other types of wireless devices. A biometric imaging apparatus (not illustrated) may be incorporated into each of the devices to be paired, for obtaining the biometric information from the user or another person. Alternatively, the biometric imaging apparatus may be separate from the devices, in which case biometric information retrieved from the apparatus is transferred to the devices to be paired. Each device may have the capability to store the biometric information retrieved by the biometric imaging apparatus, as well as the capability to produce a PIN code which will subsequently be used to create the link key.

In steps 202 and 204 of the method, a sample of biometric information is obtained for the first device and the second device, from a user who will subsequently use the paired devices, or from another individual. The type of biometric information sample obtained from the user or other individual may include, without limitation, a finger print, a palm print, a toe print, a retinal image, a hand geometry sample, a handwriting sample, or a genetic sample. For example, in the case of a fingerprint, the user or other person may place a finger in or on the biometric imaging device, at which time the biometric imaging device scans the fingerprint and stores the fingerprint in the first device. Alternatively, the fingerprint can be transferred to the first device in a situation where the first device and the biometric imaging device are physically separated from each other.

In steps 206 and 208 of the method, a PIN code is generated or produced by the first device and the second device, using the biometric information samples obtained in steps 202 and 204. The PIN code may be a multi-byte PIN code having, for example, at least 16 bytes, and may be numeric or alphanumeric, for example. The PIN code may be created according to any of a variety of well-known techniques. For example, the PIN code may be generated using a mathematical transformation of the biometric information sample. Furthermore, the biometric information sample may be matched to a biometric template previously stored in each device. Because the biometric information sample obtained in steps 202 and 204 are from the same person, the PIN codes resulting from steps 206 and 208 should be identical.

Alternatively, steps 204 and 208 can be replaced by a single step where the PIN code for the second device is a manual entry of the PIN code produced for the first device using a biometric information sample in step 206. In this situation, the PIN code produced by the first device is also displayed or otherwise conveyed to a user in step 206.

In a next step 210 of the method, the same PIN code, generated in steps 206 and 208, is used to create a link key that is stored in the first device and the second device and may be subsequently used for the paired exchange of information between the first and second devices. For example, the PIN code may be combined with certain fixed data and certain ephemeral data to formulate the link key, as is well understood by those skilled in the art.

In the event that a user other than the initial user is to use the devices, provision may be made for changing the link key for the first and second devices by erasing or deleting the first link key of the initial user from both devices, and then generating a new link key for the second user in both devices, typically by carrying out steps 202, 204, 206, 208, 210 of FIG. 2.

The embodiments of the present invention are suitable for producing a link key for first and second devices which may be permanently paired with each other, in which case the link key is typically used to initiate communication between the devices each time communication between the devices is requested. The embodiments are also suitable for producing a link key for devices which are to be temporarily paired with each other for only a single communication instance or data exchange. In that case, the PIN code is entered into both of the devices using a biometric information sample as was heretofore set forth in steps 202, 204, 206, 208, 210 of FIG. 2. The PIN code is used to generate the link key, which may be used for authentication of the transaction, and may be used for encryption of the transaction. After the transaction, the PIN code and the link key may be erased or deleted.

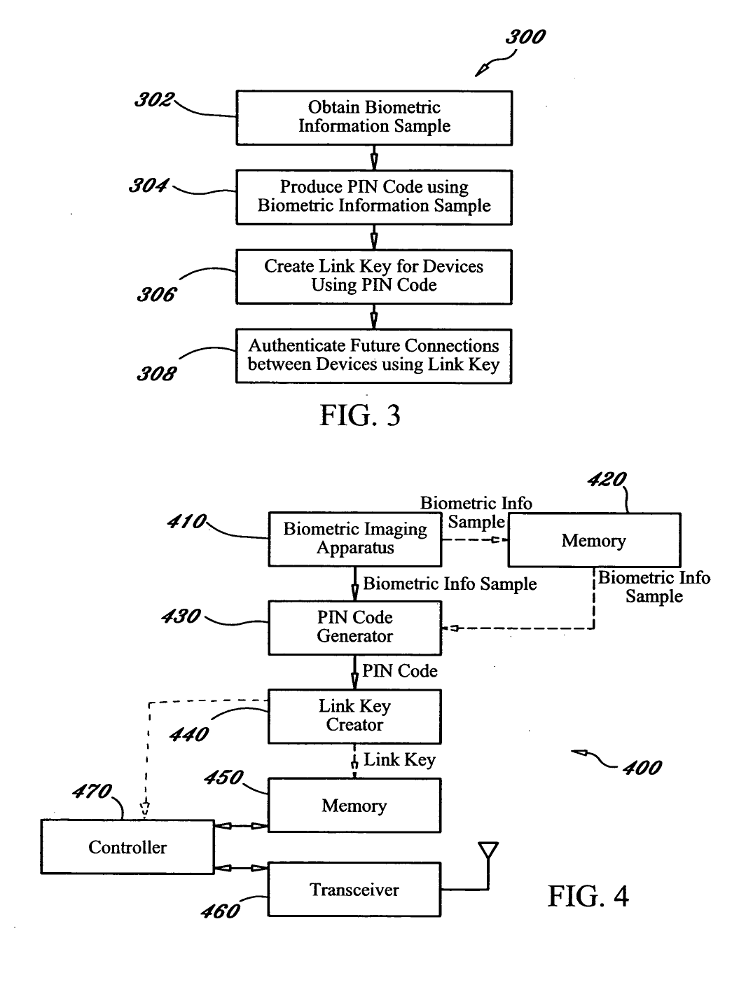

Referring to FIG. 3, a flow diagram 300 provides an illustrative embodiment of a method of entering a PIN code, creating a link key, and using the link key to authenticate future communications between two or more devices in accordance with some embodiments. The devices, for which the link key is to be used for authentication of future wireless communications, may be any type of device for which the paired and secured exchange of information between the devices is desired. In step 302 of the method, a biometric information sample is obtained typically from a device user or from another individual. The type of biometric information sample which is obtained from the user or other person may include, but is not limited to, a finger print, a palm print, a toe print, a retinal image, a hand geometry sample or a handwriting sample. The biometric information sample may be obtained using a biometric imaging apparatus (not illustrated) which may be incorporated into a device or each of multiple devices to be paired. Alternatively, the biometric imaging apparatus may be physically separate from the device(s) to be paired; in which case the biometric information sample obtained from the user is transferred from the apparatus to the device or devices.

In subsequent step 304, a PIN code is produced or generated using the biometric information sample obtained in step 302. The PIN code is typically a numeric or alphanumeric PIN code having a selected number of bytes. In some embodiments, the PIN code may be produced and entered into both devices using the biometric information sample. However, the invention contemplates other embodiments in which the PIN code is produced and entered into one device using the biometric information sample provided by the user or other individual, and independently entered into the other device(s) using an alternative method or technique such as using a numeric or alphanumeric keypad. In step 306, a link key is created for at least one of the devices using the PIN code which was produced using the biometric information sample in step 304. In step 308, the link key is used to authenticate future communications between the devices, and possibly to encrypt information exchanged between the devices. By entering the PIN code into a device using a biometric information sample, the device can be easily authenticated. Entering the PIN code could thus become simply using a biometric imaging apparatus such as a fingerprint scanner. Alternatively, the user could memorize or record the PIN code produced using the biometric information sample and enter it into the device via a keypad or wired communication port. In this manner, future communications for the paired exchange of information between the devices is secure and susceptibility to “sniffing” or eavesdropping by unpaired devices is reduced.

Referring next to FIG. 4, an apparatus for creating a PIN code and a link key for multiple devices according to some embodiments is generally indicated by reference numeral 400. The apparatus 400 is suitable for implementation with any device or devices which are to be paired using a secure link key, including but not limited to pagers, mobile phones, personal computers, printers, keyboards, facsimile machines, modems, network interfaces devices (LAN or WAN connection devices, for example), digital cameras, headphones, and other types of wireless devices.

The apparatus 400 includes a biometric imaging apparatus 410 capable of receiving a biometric sample from a user or other person. The biometric imaging apparatus 410 may be any apparatus capable of obtaining a biometric information sample from the user or other person. The biometric information sample may include, but is not limited to, a fingerprint, a palm print, a toe print, a retinal image, a hand geometry sample or a handwriting sample. A memory storage component 420 may interface with the biometric imaging apparatus 410. Preferably, the memory storage component 420 is adapted to store, in a recordable format, a biometric information sample obtained from a user or other person using the biometric imaging apparatus 410.

A PIN code generator 430 interfaces with the biometric imaging apparatus 410. The PIN code generator 430 may be adapted to receive the biometric information sample obtained from the user or other person using the biometric imaging apparatus 410. The PIN code generator 430 may be configured to receive the biometric information sample directly from the biometric imaging apparatus 410 or indirectly from the biometric imaging apparatus 410 via the memory storage component 420. The PIN code generator 430 is capable of generating a PIN code based on the biometric information sample obtained by the biometric imaging apparatus 410, according to any available technique. For example, the PIN code generator 430 may generate the PIN code based on characteristics of the biometric information sample itself, such as a mathematical transformation of the biometric information sample. Alternatively, multiple PIN codes may be stored in the PIN code generator 430 in association or linkage with multiple biometric templates, or stored patterns or images, of the type of biometric information sample, such as fingerprint, palm print, toe print, retinal image, a hand geometry sample or handwriting sample, for example, which the biometric imaging apparatus 410 obtains from the user or other person. In this case, the PIN code generator 430 pairs the sample of biometric information, previously obtained from the user or other person by the biometric imaging apparatus 410, with the stored biometric template matching, or most closely resembling, the biometric information sample. The PIN code associated with a matching biometric template, or the biometric template most closely resembling the sample, is the PIN code subsequently used to create the link key for the device.

A link key creator 440 interfaces with the PIN code generator 430. The link key creator 440 creates a link key that is subsequently used for the paired exchange of information between the first and second devices. For example, the link key creator 440 may combine the PIN code with certain fixed data and/or certain ephemeral data to formulate the link key, as is well understood by those skilled in the art. A memory 450 may interface with the link key creator 440 and is adapted to store the link key in a recordable format.

A controller 470 interfaces with a memory storage component 450 of the link key creator 440 and with a transceiver 460. The controller 470 is adapted to receive the link key from the memory storage component 450 of the link key creator 440 and to control transmission of the link key from the transceiver 460 to a transceiver (not illustrated) of the other paired device (not illustrated). The controller 470 is also adapted to receive a link key from the transceiver (not illustrated) of the other paired device and compare it with the link key generated by the link key creator 440 of the apparatus 400. In the event that the link key previously created by the link key creator 440 of the apparatus 400 is the same as that which was received from the other paired device, the controller 470 is adapted to authorize communications between the paired devices and to facilitate the secure and paired exchange of information between the devices via the transceiver 460. On the other hand, in the event that the link key created by the link key creator 440 of the apparatus 400 is not the same as that which was received from the other paired device, the controller 470 prevents communication, and therefore the paired exchange of information, between the devices. This prevents “eavesdropping” of information transmitted from the transceiver 460 of the apparatus 400 by an unauthorized device during the paired exchange of information between the paired devices.

The apparatus 400 may be included as a component of one or each of the devices to be paired using a secure link key. Alternatively, any, some or all components of the apparatus 400 may be physically separate from either or both of the devices intended to be paired using a link key. Various combinations of the components of the apparatus 400 with each or both of the devices to be paired are also possible. For example, in some embodiments, the biometric imaging apparatus 410, the memory 420 and the PIN code generator 430 may be separate from the device, which would include the link key creator 440, the memory storage component 450, the transceiver 460 and the controller 470. In other embodiments, the biometric imaging apparatus 410 and memory storage component 420 may be separate from the device, which would include the PIN code generator 430, the link key creator 440, the memory 450, the transceiver 460 and the controller 470.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims, including any amendments made during the pendency of this application, and all equivalents of those claims as issued.

1. A method for creating and entering a personal identification number (PIN) code for a secure wireless communication, comprising:
obtaining a biometric information sample;
utilizing a transform function to transform the biometric information sample into a PIN code; and
creating a link key using said PIN code.

2. The method of claim 1 wherein the obtaining a biometric information sample further comprises obtaining at least one of: a fingerprint sample, a palm print sample, a toe print sample, a retina image sample, a hand geometry sample and a handwriting sample.

3. The method of claim 1 wherein the step of utilizing further comprises producing a numeric PIN code.

4. The method of claim 1 wherein the step of utilizing further comprises producing an alphanumeric PIN code.

5. The method of claim 1 wherein the step of utilizing further comprises producing a PIN code having at least 16 bytes.

6. (canceled)

7. A method for creating and entering a personal identification number (PIN) code for a plurality of devices, comprising:
obtaining a first biometric information sample for a first device;
utilizing a transform function to transform the biometric information sample into a first PIN code;
obtaining a second biometric information sample for a second device;
utilizing the transform function to transform the biometric information sample into a second PIN code identical to said first PIN code using said second biometric information sample; and
creating a link key for said first device and said second device using said first PIN code and said second PIN code.

8. The method of claim 7 wherein said first biometric information sample comprises at least one of: a fingerprint sample, a palm print sample, a toe print sample, a retina image sample, a hand geometry sample and a handwriting sample.

9. The method of claim 7 wherein said PIN code comprises an alphanumeric PIN code having at least 16 bytes.

10. The method of claim 7 wherein said PIN code comprises a numeric PIN code having at least 16 bytes.

11. canceled

12. canceled

13. canceled

14. canceled

15. canceled

16. canceled

17. canceled

18. An apparatus for creating and entering a personal identification number (PIN) code and creating a link key for multiple devices, comprising:
a biometric imaging apparatus;
a PIN code generators, interfacing with said biometric imaging apparatus, to receive a biometric information sample from the biometric imaging apparatus and to utilize a transform function to transform the biometric information sample into a PIN code; and
a link key creators, interfacing with said PIN code generator, to create a link key through employment of the PIN code.

19. The apparatus of claim 18 further comprising a controller interfacing with said link key creator.

20. The apparatus of claim 19 further comprising a transceiver interfacing with said controller.

21. The apparatus of claim 18 wherein a first one of said multiple devices comprises a mobile telephone and a second one of said multiple devices comprises a wireless headset.
